(19) United States
(12) Patent Application Publication
(10) Pub. No.: US 2020/0142114 A1
(43) Pub. Date: May 7, 2020

(54) PLANAR DISPLAY AND METHOD OF PREPARING SAME

(71) Applicant: WUHAN CHINA STAR OPTOELECTRONICS TECHNOLOGY CO., LTD., Wuhan Hubei (CN)

(72) Inventors: Guizhi MA, Wuhan Hubei (CN); Yongkai LI, Wuhan Hubei (CN)

(73) Assignee: WUHAN CHINA STAR OPTOELECTRONICS TECHNOLOGY CO., LTD., Wuhan Hubei (CN)

(21) Appl. No.: 16/334,014

(22) PCT Filed: Jan. 3, 2019
(86) PCT No.: PCT/CN2019/070202

§ 371 Date: Mar. 17, 2019

(30) Foreign Application Priority Data
Oct. 31, 2018 (CN) 201811281903.6

(51) Int. Cl. G02B 5/30

(52) U.S. Cl. CPC G02B 5/305

(57) ABSTRACT

The present invention provides a polarizing plate and a method of preparing the same, wherein the polarizing plate comprises a polyvinyl alcohol layer (PVA) and a support layer, the support layer is in contact with and supports the polyvinyl alcohol layer; wherein the support layer is a curing glue coating composed of at least one of a heat curing material, an optical glue, and a UV curing glue, and has a thickness of 5-20 μm. The present invention adopts a novel structure design of a polarizing plate, and uses a curing glue coating to support and protect the polyvinyl alcohol layer. The curing glue coating can effectively reduce the thickness on the basis of realizing the same effect of an existing COP/TAC/CAT support layer, thereby reducing an overall thickness of the polarizing plate.

### BACKGROUND OF INVENTION

### Field of Invention

The present invention relates to a field of planar display technology, and in particular, to a polarizing plate which can be used in a planar display panel and a method of preparing the same.

### Description of Prior Art

It is known that liquid crystal displays or OLED displays are widely used and widely accepted by the market due to their advantages of lightness, thinness, and good display performance. However, market demands for lightness and thinness of screens are constantly elevated.

In recent years, due to continuous demands for thickness reduction of a whole device by mobile phone manufacturers, the thickness of a mobile phone screen (TFT-LCD\OLED) continues to get thinner. A polarizing plate is one of the main structures of the screen, and a thickness of a main body of the polarizing plate is also required to be able to be thinner and thinner while maintaining normal function, thereby reducing the overall thickness of the screen.

In this regard, the industry continues to reduce the thickness of the polarizing plate from 200 μm of the original single polarizer, and gradually reduces the overall thickness to 100 μm through thinning TAC and PVA structures. Now, polarizing plate suppliers began exploring further reductions in thickness by replacing the TAC with a thinner COP material.

Furthermore, the overall thickness is reduced to about 80 μm by reducing the TAC layer. Considering the problems of support strength shrinkage and reliability, the polarizing plate (POL) with the reduced number of TAC layers is mostly used in the lower polarizing plate with a reflection enhancing film, so that the overall thickness of the upper and lower polarizing plates can be reduced to about 160 um.

Specifically, please refer to FIG. 10, which illustrates a structure of a conventional polarizing plate. As shown in the figure, because the conventional COP/TAC/CAT support layer involved is thick, having a thickness of about 10 to 50 μm, so that the overall thickness of the existing polarizing plate is relatively thick.

Although the thickness of the polarizing plate is continuously reduced, the industry's demand for the reduction in the thickness of the polarizing plate has not stopped, and an implementable solution capable of reducing the overall thickness of the polarizing plate is being continuously explored.

### SUMMARY OF INVENTION

An aspect of the present invention is to provide a polarizing plate that adopts a novel structural design, such that an overall thickness is reduced, so that the planar display panel on which it is equipped is lighter and thinner, thereby meeting industry's demands.

The technical solution adopted by the present invention is as follows:

A polarizing plate comprises a polyvinyl alcohol layer (PVA) and a support layer, the support layer is in contact with and supports the polyvinyl alcohol layer; wherein the support layer is a curing glue coating composed of at least one of a heat curing material, an optical glue, and a UV curing glue.

The present invention adopts a polarizing plate having a novel structure design, and uses a curing glue coating to replace the existing common support layers such as COP/TAC/CAT, and to support and protect the polyvinyl alcohol layer. The curing glue coating can effectively reduce the thickness based on realizing the same effect as the existing COP/TAC/CAT support layer, thereby reducing the overall thickness of the polarizing plate.

Specifically, the curing glue coating may be selected from a heat curing material, such as modified polyurethane series; an optical glue; or a UV curing glue, for example, modified polyurethane acrylate series.

Further, in various embodiments, the support layer has a thickness of 5-20 μm.

Further, the polyvinyl alcohol (PVA) layer may also be an equivalent structure layer composed of a similar material, for example, an MSPVA layer. The polyvinyl alcohol (PVA) layer is for illustrative purposes only and is not limited.

Further, in various embodiments, the support layer is disposed on the upper and/or lower surface of the polyvinyl alcohol layer.

Further, in various embodiments, the support layer comprises two layers respectively disposed on an upper side and a lower side of the polyvinyl alcohol layer, wherein a protective film is provided on the support layer on the upper side, while a pressure sensitive adhesive and a release film are sequentially disposed under the support layer on the lower side.

Further, in various embodiments, the support layer is disposed on an upper side of the polyvinyl alcohol layer, and a protective film is disposed on the support layer, while a pressure sensitive adhesive and a release film are sequentially disposed under the polyvinyl alcohol layer.

Further, in various embodiments, the support layer comprises two layers respectively disposed on an upper side and a lower side of the polyvinyl alcohol layer, and a reflection enhancing film and a protective film are provided on the support layer on the upper side sequentially, while a pressure sensitive adhesive and a release film are sequentially disposed under the support layer on the lower side.

Further, in various embodiments, wherein the support layer is disposed on a lower side of the polyvinyl alcohol layer, and a pressure sensitive adhesive and a release film are sequentially disposed under the support layer, while a reflection enhancing film and a protective film are sequentially disposed on the polyvinyl alcohol layer.

Further, in various embodiments, the support layer is coated on the polyvinyl alcohol layer after the polyvinyl alcohol layer is stretched.

Further, in various embodiments, the support layer is cured on the polyvinyl alcohol layer by a heat curing or a UV curing.

Further, in various embodiments, the support layer is simultaneously subjected to a surface functional treatment during the coating process. For example, HC, AG, and LR, etc., but not limited thereto.

Further, depending on desired functional treatments of the surface, the support layer may be added with different substances such as SiO2 particles or the like. Furthermore, the material and the thickness of the support layer should also be adjusted accordingly in view of the flexibility of the used material. Further, the side of the polyvinyl alcohol layer in contact with the pressure sensitive adhesive (PSA) and the side of the polyvinyl alcohol layer in contact with the reflection enhancing film (APF) may have no curing glue coating thereon, because the pressure sensitive adhesive/reflection enhancing film can also play a supporting role.

Another aspect of the present invention is to provide a method of preparing the polarizing plate according to the present invention, wherein the polarizing plate adopts a novel structural design, resulting in less manufacturing processes and less manufacturing materials, thereby reducing the production cost of the polarizing plate of the present invention.

The technical solutions adopted are as follows:

A method of preparing the polarizing plate is provided, comprising the following steps: a polyvinyl alcohol layer dyeing step, wherein the polyvinyl alcohol layer is immersed in an aqueous solution of iodine for dyeing, and replaced with iodide ions to achieve absorption of light of different wavelengths; a polyvinyl alcohol layer stretching step, wherein the polyvinyl alcohol layer after dyeing is stretched to 5 to 15 times an original length, with a thickness controlled between 10 μm and 30 μm; a polyvinyl alcohol layer cleaning and pre-baking step, wherein the polyvinyl alcohol layer after stretching is cleaned, and dried after cleaning; a support layer coating step, wherein the polyvinyl alcohol layer after dyeing and drying is coated with a curing glue, which comprises at least one of a heat curing material, an optical glue, and a UV curing glue, having a coating thickness of 5-20 μm; a curing step, wherein the polyvinyl alcohol layer after coating is subjected to a heat curing treatment or a UV light curing treatment according to a material of the support layer.

Further, in various embodiments, in the polyvinyl alcohol layer stretching step, the polyvinyl alcohol layer is stretched in an aqueous solution of boric acid and potassium iodide.

Further, in various embodiments, in the polyvinyl alcohol layer cleaning and pre-baking step, the polyvinyl alcohol layer is cleaned by an aqueous solution with an addition of at least one substance of zinc sulfate, zinc chloride, potassium iodide, potassium chloride, and boric acid, to improve uniformity and material strength of the polyvinyl alcohol layer and to remove surface contamination.

Further, in various embodiments, in the polyvinyl alcohol layer cleaning and pre-baking step, the polyvinyl alcohol layer after cleaning is dried at a temperature of 50 to 120° C. for 0 to 60 minutes. The process should be careful not to over-dry, as long as the surface of the polyvinyl alcohol layer is dried.

Further, in various embodiments, a pressure sensitive adhesive (PSA) coating step is further included, wherein a pressure sensitive adhesive is coated to a composite of the cured polyvinyl alcohol layer and the curing glue coating, or it may be carried out by a release film transfer method.

Further, in various embodiments, a reflection enhancing film coating (lower polarizing plate) step is further included, wherein the process is similar to the existing process, and details are not repeated herein for brevity.

Compared with the prior art, the present invention has the beneficial effects that the present invention relates to a polarizing plate which adopts a novel structural design and replaces a conventional COP/TAC/CAT supporting layer with a curing glue coating. The curing glue coating provides the same support and protection functions, but due to the thinner thickness required, the overall thickness of the polarizing plate is thinner, so that the display panel in which it resides is lighter and thinner, thereby meeting the requirements of the industry.

In addition, the thickness of the polarizing plate is reduced, reserving more space for the stack of the TFT-LCD module, thereby further optimizing the brightness requirement of the whole device.

In addition, in the method of preparing the polarizing plate according to the present invention, since the polarizing plate adopts a novel structure and material, the manufacturing process is simplified and the manufacturing material is reduced, thereby realizing reduction in the manufacturing cost of the polarizing plate, thus further enhancing the competitiveness of the product.

### BRIEF DESCRIPTION OF DRAWINGS

FIG. 1 is a schematic structural view of a polarizing plate according to an embodiment of the present invention.

FIG. 2 is a schematic structural view of a polarizing plate according to further another embodiment of the present invention.

FIG. 3 is a schematic structural view of a polarizing plate according to still another embodiment of the present invention.

FIG. 4 is a schematic structural view of a polarizing plate according to also another embodiment of the present invention.

FIG. 5 is a schematic structural diagram of a polarizing plate according to still another embodiment of the present invention.

FIG. 6 is a schematic structural view of a polarizing plate according to still another embodiment of the present invention.

FIG. 7 is a schematic structural view of a polarizing plate according to still another embodiment of the present invention.

FIG. 8 is a schematic structural view of a polarizing plate according to still another embodiment of the present invention.

FIG. 9 is a schematic structural view of a polarizing plate according to still another embodiment of the present invention.

FIG. 10 is a schematic structural view of a structure of a polarizing plate of the prior art.

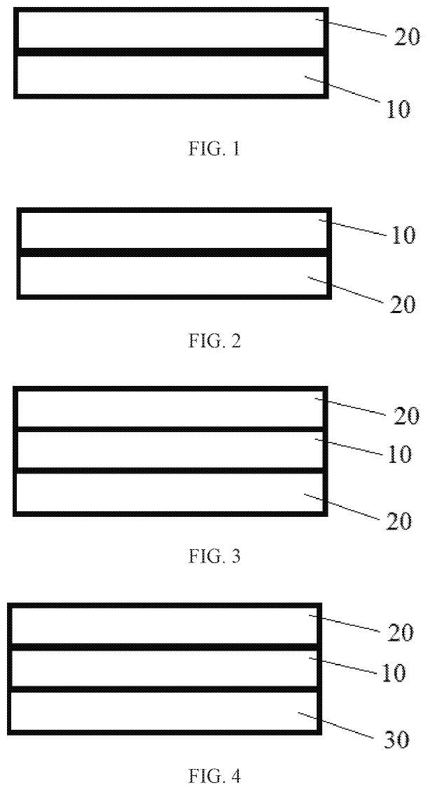

The reference numerals in FIGS. 1 to 10 denote the components as follows:
Polyvinyl alcohol (PVA) layer 10
Support layer 20
Pressure Sensitive Adhesive (PSA) 30
Reflection enhancing Film (APF) 40
Release film 50
Protective film 60

### DETAILED DESCRIPTION OF PREFERRED EMBODIMENTS

The technical solutions of a polarizing plate and a preparing method thereof according to the present invention will be further described in detail below with reference to the accompanying drawings and embodiments.

An embodiment of the present invention provides a polarizing plate comprising a polyvinyl alcohol (PVA) layer and a support layer, wherein the support layer is in contact with and supports the PVA layer, wherein the support layer is a curing glue coating composed of at least one of a heat curing material, an optical glue, and a UV curing glue, and has a thickness of 5-20 μm.

The present invention adopts a polarizing plate with a novel structural design, and uses a curing glue coating to replace the existing common support layer such as COP/TAC/CAT, and to support and protect the polyvinyl alcohol layer. The curing glue coating can effectively reduce the thickness based on realizing the same effect as the existing COP/TAC/CAT support layer, thereby reducing the overall thickness of the polarizing plate.

Specifically, the curing glue coating may be selected from a heat curing material, such as modified polyurethane series; an optical glue; and a UV curing glue, for example, modified polyurethane acrylate series.

Further, according to different specific needs, the arrangement between the polyvinyl alcohol (PVA) layer and the support layer may include three types.

Referring to FIG. 1, in the first arrangement, the support layer 20 is disposed on the polyvinyl alcohol (PVA) layer 10. Referring to FIG. 2, in the second arrangement, the support layer 20 is disposed under the polyvinyl alcohol (PVA) layer 10. Referring to FIG. 3, in the third arrangement, the support layers 20 are disposed above and below the polyvinyl alcohol (PVA) layer 10. The specific method may be selected according to the specific structure of the polarizing plate, and is not specifically limited.

For example, referring to FIGS. 4 and 5, in two embodiments of the polarizing plate of the present invention, the side of the polyvinyl alcohol layer 10 in contact with the pressure sensitive adhesive (PSA) 30 and the side of the polyvinyl alcohol layer 10 in contact with the reflection enhancing film (APF) 40 may have no support layer 20 thereon, and the pressure sensitive adhesive 30/reflection enhancing film 40 can also play a supporting role.

Further, according to the inventive concept of the present invention described above, the polarizing plate of the present invention may have the following specific structures.

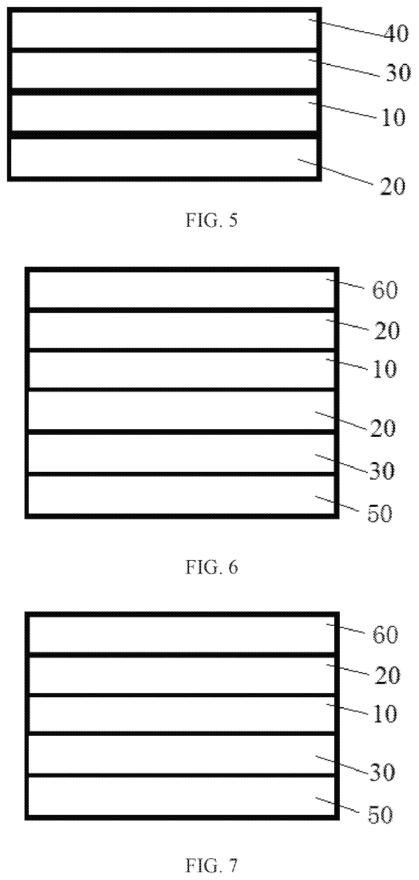

Referring to FIG. 6, another embodiment of the present invention provides a polarizing plate including a protective film 60, a support layer 20, a polyvinyl alcohol layer 10, a support layer 20, a pressure sensitive adhesive 30, and a release film 50.

Referring to FIG. 7, further another embodiment of the present invention provides a polarizing plate comprising a protective film 60, a support layer 20, a polyvinyl alcohol layer 10, a pressure sensitive adhesive 30, and a release film 50.

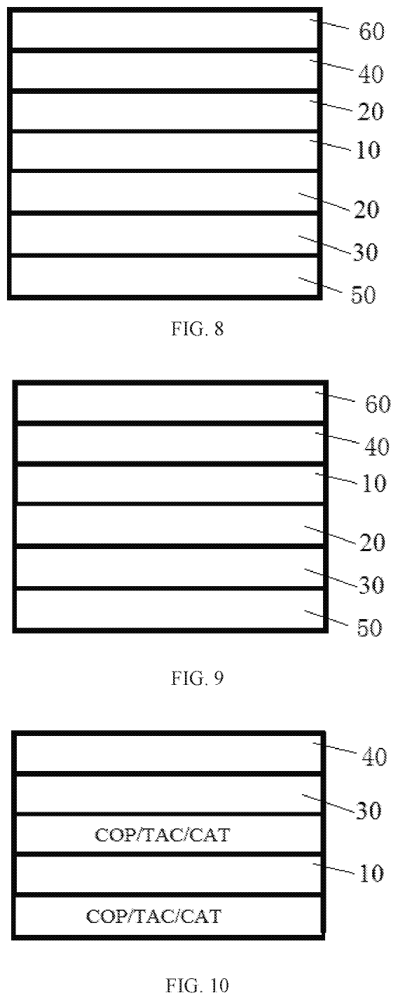

Referring to FIG. 8, still another embodiment of the present invention provides a polarizing plate including a protective film 60, a reflection enhancing film 40, a support layer 20, a polyvinyl alcohol layer 10, a support layer 20, a pressure sensitive adhesive 30, and a release film 50.

Referring to FIG. 9, also another embodiment of the present invention provides a polarizing plate including a protective film 60, a reflection enhancing film 40, a polyvinyl alcohol layer 10, a support layer 20, a pressure sensitive adhesive 30, and a release film 50.

The specific film structures of the polarizing plates disclosed above are merely illustrative examples of the inventive concept of the present invention. The specific film structure can be added or deleted according to actual needs, and is not limited.

Further, depending on the desired functional treatments of the surface, the support layer may be added with different substances such as SiO2 particles or the like. Furthermore, the material and the thickness of the support layer should also be adjusted accordingly in view of the flexibility of the used material.

Further, the polyvinyl alcohol (PVA) layer may also be an equivalent structure layer composed of a similar material, for example, an MSPVA layer. The polyvinyl alcohol (PVA) layer is for illustrative purposes only and is not limited.

The present invention relates to a polarizing plate which adopts a novel structural design and replaces a conventional COP/TAC/CAT supporting layer with a curing glue coating. The curing glue coating provides the same support and protection functions, and thus the overall thickness of the polarizing plate is thinner, so that the display panel is lighter and thinner, thereby meeting the requirements of the industry. In addition, the thickness of the polarizing plate is reduced, reserving more space for the stack of the TFT-LCD module, thereby further optimizing the brightness requirement of the whole device.

Still another aspect of the present invention provides a method of preparing the polarizing plate according to the present invention, wherein the polarizing plate adopts a novel structural design, resulting in less manufacturing processes and less manufacturing materials, thereby reducing the production cost of the polarizing plate of the present invention.

A method for producing a polarizing plate, includes a polyvinyl alcohol layer dyeing step, a polyvinyl alcohol layer stretching step, a polyvinyl alcohol layer cleaning and pre-baking step, a support layer coating step, a curing step, a pressure sensitive adhesive (PSA) coating step, and a reflection enhancing film coating (lower polarizing plate) step.

In the polyvinyl alcohol layer dyeing step, the polyvinyl alcohol (PVA) layer is immersed in an aqueous solution of iodine for dyeing, and replaced by iodide ions to achieve absorption of light of different wavelengths;

In the stretching step of the polyvinyl alcohol layer, the polyvinyl alcohol layer after dyeing is stretched 5 to 15 times an original length, and the thickness is controlled to be 10 to 30 μm. The stretching of the polyvinyl alcohol layer is carried out in an aqueous solution of boric acid and potassium iodide.

In the polyvinyl alcohol layer cleaning and pre-baking step, it can be specifically divided into two steps: a cleaning step and a pre-baking step.

In the cleaning step, the polyvinyl alcohol layer is cleaned by an aqueous solution with an addition of at least one substance of zinc sulfate, zinc chloride, potassium iodide, potassium chloride, and boric acid, to improve uniformity and material strength of the polyvinyl alcohol layer and to remove surface contamination.

In the pre-baking step, the polyvinyl alcohol layer after cleaning is dried at a temperature of 50 to 120° C. for 0 to 60 minutes. The process should be careful not to over-dry, as long as the surface of the polyvinyl alcohol layer is dried.

In the supporting layer coating step, the polyvinyl alcohol layer after dyeing and drying is coated with a curing glue, wherein the material used is at least one of a heat curing material, an optical glue, and a UV curing glue, having a coating thickness of 5-20 μm.

In the curing step, the polyvinyl alcohol layer after coating is subjected to a heat curing treatment or a UV light curing treatment according to a material of the support layer.

In the pressure sensitive adhesive (PSA) coating step, a pressure sensitive adhesive is coated to a composite of the cured polyvinyl alcohol layer and the curing glue coating, or it may be carried out by a release film transfer method.

In the reflection enhancing film coating (lower polarizing plate) step, the process is similar to the existing process, and details are not repeated herein for brevity.

According to the method of preparing the polarizing plate of the present invention, because the polarizing plate adopts a new structure and material, the manufacturing process is simplified and the manufacturing material is reduced, thereby realizing a reduction in the manufacture cost of the polarizing plate according to the present invention, thus further enhancing the competitiveness of the product.

While the invention has been described in detail and with reference to specific embodiments thereof, it is to be understood that the foregoing description is exemplary and explanatory in nature and is intended to illustrate the invention and its preferred embodiments. Through routine experimentation, one skilled in the art will readily recognize that various changes and modifications can be made therein without departing from the spirit and scope of the invention.

What is claimed is:

1. A polarizing plate, comprising a polyvinyl alcohol layer and a support layer, wherein the support layer is in contact with and supports the polyvinyl alcohol layer;
wherein the support layer is a curing glue coating composed of at least one of a heat curing material, an optical glue, and a UV curing glue.

2. The polarizing plate according to claim 1, wherein the support layer has a thickness of 5-20 μm.

3. The polarizing plate according to claim 1, wherein the support layer is provided on an upper surface and/or a lower surface of the polyvinyl alcohol layer.

4. The polarizing plate according to claim 1, wherein the support layer comprises two layers respectively disposed on an upper side and a lower side of the polyvinyl alcohol layer, wherein a protective film is provided on the support layer on the upper side, while a pressure sensitive adhesive and a release film are sequentially disposed under the support layer on the lower side.

5. The polarizing plate according to claim 1, wherein the support layer is disposed on an upper side of the polyvinyl alcohol layer, and a protective film is disposed on the support layer, while a pressure sensitive adhesive and a release film are sequentially disposed under the polyvinyl alcohol layer.

6. The polarizing plate according to claim 1, wherein the support layer comprises two layers respectively disposed on an upper side and a lower side of the polyvinyl alcohol layer, and a reflection enhancing film and a protective film are provided on the support layer on the upper side sequentially, while a pressure sensitive adhesive and a release film are sequentially disposed under the support layer on the lower side.

7. The polarizing plate according to claim 1, wherein the support layer is disposed on a lower side of the polyvinyl alcohol layer, and a pressure sensitive adhesive and a release film are sequentially disposed under the support layer, while a reflection enhancing film and a protective film are sequentially disposed on the polyvinyl alcohol layer.

8. A method of preparing the polarizing plate according to claim 1, comprising the following steps:
a polyvinyl alcohol layer dyeing step, wherein the polyvinyl alcohol layer is immersed in an aqueous solution of iodine for dyeing, and replaced with iodide ions to achieve absorption of light of different wavelengths;
a polyvinyl alcohol layer stretching step, wherein the polyvinyl alcohol layer after dyeing is stretched to 5 to 15 times an original length, with a thickness controlled between 10 μm and 30 μm;
a polyvinyl alcohol layer cleaning and pre-baking step, wherein the polyvinyl alcohol layer after stretching is cleaned, and dried after cleaning;
a support layer coating step, wherein the polyvinyl alcohol layer after dyeing and drying is coated with a curing glue, which comprises at least one of a heat curing material, an optical glue, and a UV curing glue, having a coating thickness of 5-20 μm;
a curing step, wherein the polyvinyl alcohol layer after coating is subjected to a heat curing treatment or a UV light curing treatment according to a material of the support layer.

9. The method of preparing the polarizing plate according to claim 8, wherein in the polyvinyl alcohol layer stretching step, the polyvinyl alcohol layer is stretched in an aqueous solution of boric acid and potassium iodide.

10. The method of preparing the polarizing plate according to claim 8, wherein in the polyvinyl alcohol layer cleaning and pre-baking step, the polyvinyl alcohol layer is cleaned by an aqueous solution with an addition of at least one substance of zinc sulfate, zinc chloride, potassium iodide, potassium chloride, and boric acid, to improve uniformity and material strength of the polyvinyl alcohol layer and to remove surface contamination.
